(19) United States
(12) Patent Application Publication
(10) Pub. No.: US 2025/0350933 A1
(43) Pub. Date: Nov. 13, 2025

(54) METHOD AND APPARATUS FOR SECURE TRANSMISSION OF AVATAR OBJECT IN WIRELESS COMMUNICATION SYSTEM

(71) Applicant: Samsung Electronics Co., Ltd., Gyeonggi-do (KR)

(72) Inventors: Taehyung LIM, Gyeonggi-do (KR); Hongjin CHOI, Gyeonggi-do (KR)

(21) Appl. No.: 19/203,700

(22) Filed: May 9, 2025

(30) Foreign Application Priority Data
May 10, 2024 (KR) 10-2024-0062112
Aug. 8, 2024 (KR) 10-2024-0106218
Sep. 30, 2024 (KR) 10-2024-0132684
Jan. 2, 2025 (KR) 10-2025-0000371

(51) Int. Cl. H04W 12/033; G06T 13/40; H04L 9/14; H04W 12/041

(52) U.S. Cl. CPC H04W 12/033; G06T 13/40; H04L 9/14; H04W 12/041

(57) ABSTRACT

The disclosure relates to a fifth generation (5G) or sixth generation (6G) communication system for supporting a higher data transmission rate. A method performed by a transmitting UE for providing an avatar service through avatar communication includes establishing a channel for the avatar communication with a network entity and a UE receiving the avatar service, transmitting, to the network entity, attestation information including identification information of an avatar object to be used for the avatar communication by the transmitting UE, and an encryption information of a rendering entity generated by the rendering entity, and acquiring data required for rendering corresponding to the encrypted avatar object based on the encryption information of the rendering entity. The encrypted avatar object is encrypted based on verification of the attestation information and the identification information. The encrypted avatar object is provided to the rendering entity.

### CROSS-REFERENCE TO RELATED APPLICATIONS

This application is based on and claims priority under 35 U.S.C. § 119 to Korean Patent Application Nos. 10-2024-0062112, 10-2024-0106218, 10-2024-0132684, and 10-2025-0000371, which were filed in the Korean Intellectual Property Office on May 10, 2024, Aug. 8, 2024, Sep. 30, 2024, and Jan. 2, 2025, respectively, the disclosure of each of which is incorporated herein by reference in its entirety.

### BACKGROUND

### 1. Field

The disclosure relates generally to operation of a user equipment (UE), a base station, and a core network (CN), and more particularly, to a method and apparatus for secure transmission of an avatar object for Internet protocol multimedia subsystem (IMS)-based avatar communication.

### 2. Description of Related Art

Fifth generation (5G) mobile communication technologies define broad frequency bands such that high transmission rates and new services are possible, and can be implemented not only in sub 6 GHz bands such as 3.5 gigahertz (GHz) bands but also in above 6 GHz bands referred to as millimeter wave (mmWave) bands including 28 GHz and 39 GHz bands. In addition, it has been considered to implement sixth generation (6G) mobile communication technologies referred to as beyond 5G systems in terahertz (THz) bands (e.g., 95 GHz to 3 THz bands) to accomplish transmission rates fifty times faster than 5G mobile communication technologies and ultra-low latencies one-tenth of 5G mobile communication technologies.

Since the beginning of the development of 5G mobile communication technologies, to support services and to satisfy performance requirements in connection with enhanced mobile broadband (eMBB), ultra reliable low latency communications (URLLC), and massive machine-type communications (mMTC), there has been ongoing standardization regarding beamforming and massive MIMO for mitigating radio-wave path loss and increasing radio-wave transmission distances in mmWave, supporting numerologies (e.g., operating multiple subcarrier spacings) for efficiently utilizing mm Wave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR UE power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access channel for NR (2-step RACH for NR) for simplifying random access procedures. There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Such development of 5G mobile communication systems will serve as a basis for developing not only new waveforms for providing coverage in THz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

In an avatar communication scenario in which an avatar object (e.g., avatar model) of a user is used, if the avatar object is used by an unauthorized person, the user who is not an actual owner of the avatar object may pretend to be an actual owner of the avatar object, which is a security threat. Therefore, there is a need in the art for a method and apparatus by which an avatar object is to only be used by an authorized user.

### SUMMARY

The disclosure has been made to address at least the above-mentioned problems and/or disadvantages and to provide at least the advantages described below.

Accordingly, an aspect of the disclosure is to provide an apparatus and a method capable of effectively providing services in a wireless communication system.

Another aspect of the disclosure is to provide a method and apparatus for secure transmission of an avatar object for IMS based avatar communication.

In accordance with an aspect of the disclosure, a method performed by a transmitting UE for providing an avatar service through avatar communication includes establishing a channel for the avatar communication with a network entity and a UE receiving the avatar service, transmitting, to the network entity, attestation information including identification information of an avatar object to be used for the avatar communication by the transmitting UE, and an encryption information of a rendering entity generated by the rendering entity, and acquiring data required for rendering corresponding to the encrypted avatar object based on the encryption information of the rendering entity, wherein the encrypted avatar object is encrypted based on verification of the attestation information and the identification information, and wherein the encrypted avatar object is provided to the rendering entity.

In accordance with an aspect of the disclosure, a method performed by a network entity for avatar communication includes establishing a channel for the avatar communication with a transmitting UE providing an avatar service and a UE receiving the avatar service, receiving, from the transmitting UE, attestation information comprising identification information of an avatar object to be used for the avatar communication by the transmitting UE and encryption information of a rendering entity generated by the rendering entity, verifying the attestation information, acquiring an encrypted avatar object based on a result of verification of the attestation information by using the identification information, the encryption information of the rendering entity, and encryption information of the network entity generated by the network entity, and transmitting the encrypted avatar object and the encryption information of the network entity to the rendering entity.

In accordance with an aspect of the disclosure, a transmitting UE that provides an avatar service for avatar communication includes at least one processor, a transceiver; and a memory, wherein the at least one processor is configured to establish a channel for the avatar communication with a network entity and a UE receiving the avatar service, transmit, to the network entity, attestation information comprising identification information of an avatar object to be used for the avatar communication by the transmitting UE and encryption information of a rendering entity generated by the rendering entity; and acquire data required for rendering based on the encryption information of the rendering entity, wherein the encrypted avatar object is determined by encrypting the avatar object based on the verification of the attestation information and the identification information, and wherein the encrypted avatar object is provided to the rendering entity.

In accordance with an aspect of the disclosure, a network entity for avatar communication includes at least one processor, a transceiver; and a memory, wherein the at least one processor is configured to establish a channel for the avatar communication with a transmitting UE providing an avatar service and a UE receiving the avatar service; receive, from the transmitting UE, attestation information comprising identification information of an avatar object to be used for the avatar communication by the transmitting UE and encryption information of a rendering entity generated by the rendering entity; verify the attestation information; acquire an encrypted avatar object based on a result of verification of the attestation information by using the identification information, the encryption information of the rendering entity, and encryption information of the network entity generated by the network entity; and transmit the encrypted avatar object and the encryption information of the network entity to the rendering entity.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a system for IMS based avatar communication to which the disclosure is applied;

FIG. 2 illustrates a process of transmitting an avatar object for network centric avatar communication according to an embodiment;

FIG. 3 illustrates a process of transmitting an avatar object for a transmission UE centric (UE-A centric) avatar communication according to an embodiment;

FIG. 4 illustrates a process of transmitting an avatar object for reception UE centric (UE-B centric) avatar communication according to an embodiment;

FIG. 5 illustrates a process of transmitting an avatar object for UE-B centric avatar communication according to an embodiment;

FIG. 6 illustrates a structure of a UE according to an embodiment;

FIG. 7 illustrates a structure of a base station according to an embodiment; and

FIG. 8 illustrates a structure of a network entity according to an embodiment.

### DETAILED DESCRIPTION

Hereinafter, embodiments of the disclosure are described in detail with reference to the accompanying drawings. It should be noted that in the drawings, the same or similar elements are preferably denoted by the same or similar reference numerals. Detailed descriptions of known functions or configurations that may make the subject matter of the disclosure unclear will be omitted for the sake of clarity and conciseness.

Terms described below are terms defined in consideration of functions in the disclosure, which may vary according to intentions or customs of users and providers. Therefore, the definition should be made based on the content throughout this specification.

Some components are exaggerated, omitted, or schematically illustrated in the accompanying drawings. The size of each component does not fully reflect the actual size. In each drawing, the same reference numerals are given to the same or corresponding components.

Herein, an element is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The terms used herein, including technical and scientific terms, may have the same meaning as those commonly understood by a person skilled in the art to which the disclosure pertains. Such terms as those defined in a generally used dictionary may be interpreted to have similar meanings as the contextual meanings in the relevant field of art, and are not to be interpreted to have ideal or excessively formal meanings unless clearly defined in the disclosure. In some cases, even the term defined in the disclosure should not be interpreted to exclude embodiments of the disclosure.

Hereinafter, various embodiments of the disclosure will be described based on an approach of hardware. However, various embodiments of the disclosure include a technology that uses both hardware and software, and thus the various embodiments of the disclosure may not exclude the perspective of software.

In the accompanying drawings, some elements may be exaggerated, omitted, or schematically illustrated. Also, the size of each element does not completely reflect the actual size.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure.

In the following description, embodiments of the disclosure may also be easily applied to other communication systems through modifications.

As used herein, each of such phrases as “A and/or B,” “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. Such terms as “a first,” “a second,” “the first,” and “the second” may be used to simply distinguish a corresponding element from another, and does not limit the elements in other aspect (e.g., importance or order).

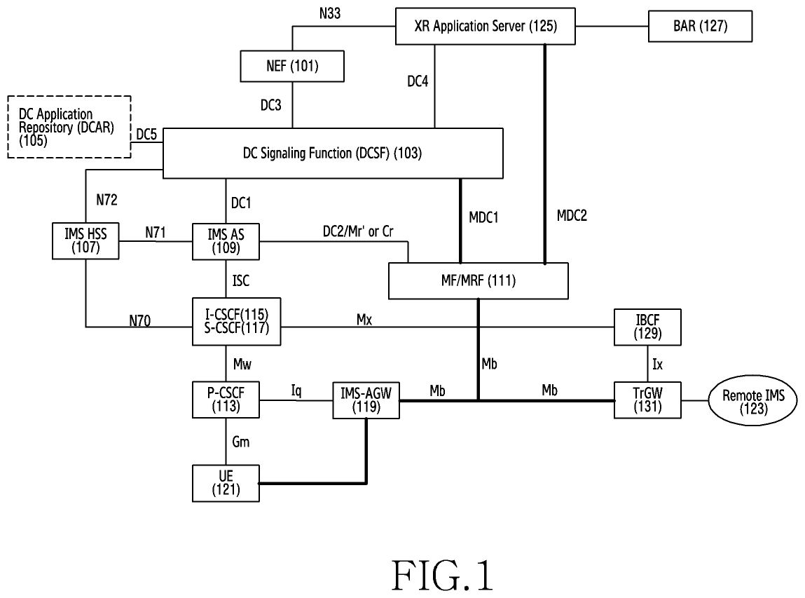

In the disclosure, reference has been made to the relevant standards defined by the international telecommunication union (ITU) or 3GPP, and components included in the network structure of FIG. 1 described later may be physical entities, software performing individual functions, or hardware combined with software. The reference numeral N1, N2, N3, . . . , Nx, or the like in drawings are the publicly known interfaces between NFs in a 5G CN.

FIG. 1 illustrates a system for IMS-based avatar communication to which the disclosure is applied.

Referring to FIG. 1, the system for IMS-based avatar communication may include various network entities which may be fewer or more entities than the network entities illustrated in FIG. 1.

A network exposure function (NEF) 101 safely exposes a network service and function to an application function (AF) via an application programming interface (API). The NEF 101 may provide a function for safely exposing services and capabilities for a 3rd party, internal exposure/re-exposure, an AF, and edge computing, and may store received information as structured data using a standardized interface based on a data storage network function. The stored information may be re-exposed to other NFs and other AFs by the NEF 101, and may be used for another purpose such as analysis or the like. However, the disclosure is not limited to the above-described example.

A data channel signaling function (DCSF) 103 may be an entity that controls a signal that provides data channel control logic.

A data channel application repository (DCAR) 105 may be an entity that stores a verified data channel application program that a DCSF retrieves when needed.

An IMS home subscriber server (IMS HSS) 107 may be a master database that authenticates an IMS service subscriber and maintains all user profile information used for authentication.

An IMS application server (IMS AS) 109 may be an entity that performs roles, such as communicating with a DCSF 103 and notifying an event, communicating with an HSS and extracting stored data channel improving service data, or communicating with a media function (MF)/multimedia resource function (MRF) according to an indication received from the DCSF 103.

An MF/MRF 111 may be an entity that provides a function of managing and forwarding a media resource of data channel media traffic.

A proxy call session control function (P-CSCF) 113 may be a server that a UE accesses first to access an IMS, and may be an entity that performs a role of routing a packet to another CSCF.

An interrogating call session control function (I-CSCF) 115 may be an entity that routes a message received from the P-CSCF 113 to a serving call session control function (S-CSCF) 117, which may be an entity that processes a message received from a P-CSCF.

An IMS access gateway (IMS-AGW) 119 may be an entity that performs a role of an access gateway that assists a P-CSCF 113 function to extend a range of devices accessible to an IMS.

An interconnection border control functions (IBCF) 129/transition gateway (TrGW) 131 may be an entity that converts between a signal and media and transfers the same so that a service is available between a home network and a remote network at an IMS network border.

A UE 121 uses an IMS service.

A remote IMS 123 is another IMS system that communicates with the IMS.

An XR application server (XR AS) 125 may be a server that manages an XR service in relation to XR communication. The XR service may include avatar communication to be described in the disclosure. That is, in the disclosure, the XR AS 125 may be a server that manages an avatar communication service. For example, the XR AS 125 may be involved in data channel establishment for avatar communication, and transmitting or receiving data (e.g., negotiation information and/or avatar object for avatar communication) for avatar communication. The role of the XR AS 125 is not limited thereto, and may be involved in all functions needed for avatar communication-related services.

A base avatar repository (BAR) 127 may be an entity that performs roles, such as storing an avatar object, and extracting and transmitting an avatar object by request of a UE and/or network.

### (1) Avatar Object, Data for Rendering, Avatar Animation, Rendering

An avatar object is a frame of an avatar used for avatar communication. A process referred to as rendering may need to be performed to enable an avatar object to express a change of a facial expression or motion, or the like. That is, data for rendering that indicates a change of a facial expression or motion is added to an avatar object. Thus, avatar animation or rendered data that expresses a lively facial expression or motion may be generated.

That is, an “avatar object” and “data for rendering” are combined, and thus “avatar animation” or “rendered data” is generated, and the process of generating an avatar animation or rendered data is referred to as rendering.

### (2) Transmission UE, Reception UE

Two end UEs that perform avatar communication herein may be referred to as a UE-A and a UE-B. In this instance, any one or both of an avatar of the UE-A and an avatar of the UE-B may be used. Although the disclosure provides embodiments from the perspective of an avatar of the UE-A for ease of description, the UE-B may also perform the same operation as that of the UE-A. That is, the perspective of the avatar of the UE-B may be easily derived by exchanging the roles of the UE-A and UE-B in the embodiments described herein.

From the perspective of the avatar of UE-A, UE-A may be a “transmission UE” that provides an avatar, and UE-B may be a “reception UE” that receives an avatar.

### (3) Network Centric, Transmission UE Centric, Reception UE Centric Models

Herein, there are three models according to subjects that performs rendering.

Network centric model: A network may be in charge of rendering. Data needed when the network is in charge of rendering may be transferred from UE-A to the network. The network may transfer rendered data to UE-B.

Transmission UE centric model: UE-A may be in charge of rendering. Data needed when UE-A is in charge of rendering may be generated by UE-A. UE-A may transfer rendered data to UE-B.

Reception UE centric model: UE-B may be in charge of rendering. Data needed when UE-B is in charge of rendering may be transferred from UE-A to UE-B.

### (4) Avatar ID, UE-a, Public Key (PK)

An avatar object of UE-A may be stored in a BAR, and may be transferred to an XR AS by request of UE-A, and may be transmitted again to a subject that is to perform rendering.

The avatar object and at least one of the following values may be stored together in the BAR.

Avatar ID: an ID indicating an avatar object of UE-A.-UE-A.PK: one of UE-A.PK and UE-A.secret key (SK) that is a public cryptosystem key pair (key pair of public cryptosystem) generated by UE-A.

IMS public user identity (IMPU): an ID that is capable of identifying an IMS service subscriber.

The BAR or IMS network entity may issue a certificate to UE-A by using UE-A.PK. The certificate may include at least one of UE-A.PK, the IMPU, the avatar ID, expiration, or a BAR signature. However, the disclosure is not limited thereto.

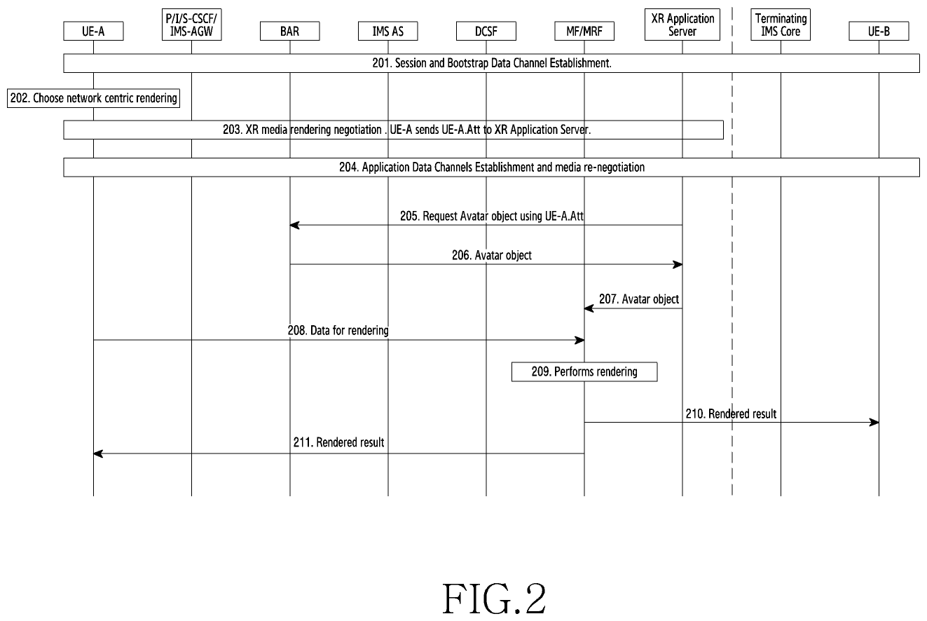

FIG. 2 illustrates a process of transmitting an avatar object for network centric avatar communication according to an embodiment.

Referring to FIG. 2, in step 201, UE-A and/or a network and/or UE-B may set up a session for avatar communication, and may establish a data channel for bootstrap data transmission.

In step 202, UE-A may select network centric-based avatar communication.

In step 203, one or more of the following processes may be performed.

UE-A and the network may perform negotiation about a rendering scheme in a process of agreeing that the following process is to be performed for avatar communication.

UE-A may transmit data needed for rendering to the network (e.g., MR/MRF).

The network (e.g., MR/MRF) may perform rendering by using an “avatar object of UE-A” and the “received data needed for rendering.”

UE-A may transmit at least one of an attestation or a certificate of UE-A to the network (e.g., XR AS). The attestation of UE-A may include one or more of the following information:

Avatar ID indicating an avatar object of UE-A.

Information indicating an XR AS. For example, information such as an identifier or address of the XR AS, or the like.

Rendering option information indicating that network centric rendering is to be performed.

Information associated with a time during which an attestation is valid. For example, expiration. As another example, a generation time and duration time of the attestation.

### IMPU

Electronic signature information generated for a portion and/or all of the information. The electronic signature may be an electronic signature generated with UE-A.SK.

Before transmitting the attestation or certificate of UE-A to the XR AS, and IMS network (e.g., DCSF, MF, or the like) may determine whether an IMPU available for UE-A is included in the information or an avatar ID available for UE-A is included, and may transmit the same to the XR-AS.

In step 204, UE-A and/or network and/or UE-B may establish a data channel for data transmission, and may perform renegotiation about media to be transmitted.

At least one of the attestation or certificate of UE-A may be transmitted in step 203 or operation 204. Alternatively, at least one of the attestation or certificate of UE-A may be transmitted in steps 203 and 204.

The attestation of UE-A may include one or more of the following information:
Avatar ID indicating an avatar object of UE-A.
Information indicating an XR AS. For example, information such as an identifier or address of the XR AS, or the like.
Rendering option information indicating that transmission UE centric rendering is to be performed.
   The generated UE-A.ePK.
   Information associated with a time during which an attestation is valid, such as expiration date or a generation time and duration time of the attestation.
   ID of UE-A (e.g., IMPU, MSISDN, IMSI, or the like).
   Electronic signature information generated for a portion and/or all of the information. The electronic signature may be generated with UE-A.SK.

Whether to transmit at least one of the attestation or certificate of UE-A in at least one of steps 203 and 204 may be determined according to implementation. For example, it may be determined based on determination or negotiation by at least one of communication entities such as a UE, a network operator, or the like.

Before transmitting the attestation or certificate of UE-A to the XR AS, the IMS network (e.g., DCSF, MF, or the like) may determine whether an IMPU available for UE-A is included in the information or an avatar ID available for UE-A is included, and may transmit the same to the XR-AS.

In step 205, the XR AS may request an avatar object of UE-A from a BAR. In step 205, the attestation or certificate of UE-A may be used.

In step 206, the BAR may perform one or more of the following processes.
Verify the attestation of UE-A. The verification may include one or more of the following processes.
   Verify validity of an electronic signature included in the certificate. The verification of the validity of the electronic signature may be performed using a public key of the BAR or a public key of the IMS network (e.g., DSCF, MF, or the like). Verify validity of an electronic signature included in the attestation of UE-A. The verification may be performed using UE-A.PK.
   Identify content included in the attestation of UE-A. The verification may include one or more of the following processes.
Determine whether UE-A having the IMPU included in the certificate is allowed to use an avatar ID included in the attestation.
Identify the avatar ID included in the attestation of UE-A, and may select and/or prepare for transmission of an avatar object of the corresponding UE-A.
Identify information of the XR AS included in the attestation of UE-A, may check whether the information of the XR AS is identical to information of the XR AS that requests the avatar object of UE-A, and may perform identification.
Identify and recognize that network centric rendering is to be performed via rendering option information included in the attestation of UE-A.
Identify time information included in the attestation of UE-A, may check whether the attestation of UE-A is still valid, and may perform identification.

When the verification succeeds, the BAR may transmit an avatar object of UE-A to the XR AS.

In step 207, the XR AS may transmit the avatar object of UE-A to the MF/MRF.

In step 208, UE-A may transmit data needed for rendering to the MF/MRF.

In step 209, the MR/MRF may perform avatar rendering using the avatar object of UE-A received from the XR AS and the data for rendering received from UE-A. As a result of avatar rendering, avatar animation may be generated.

In step 210, the MR/MRF may transmit the generated rendering result (e.g., avatar animation) to UE-B.

In step 211, the MR/MRF may transmit the generated rendering result (e.g., avatar animation) to UE-A.

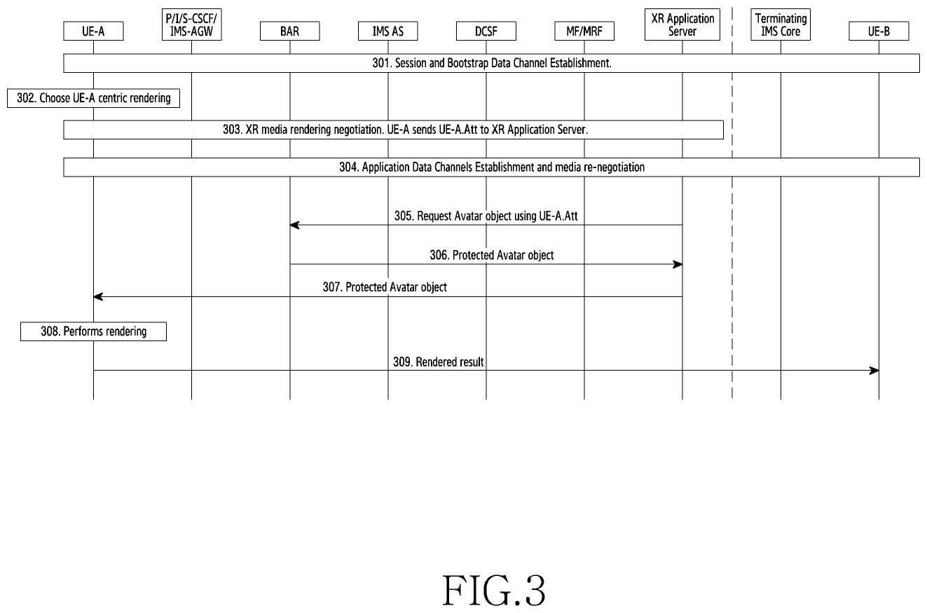

FIG. 3 illustrates a process of transmitting an avatar object for UE-A centric avatar communication according to an embodiment.

Referring to FIG. 3, in step 301, UE-A and/or a network and/or UE-B may set up a session for avatar communication, and may establish a data channel for bootstrap data transmission.

In step 302, UE-A may select UE-A centric-based avatar communication.

In step 303, one or more of the following processes may be performed.
UE-A and the network may perform negotiation about a rendering scheme, which is a process of agreeing that the following process is to be performed for avatar communication.
UE-A may perform rendering by using “its own avatar object” and “data needed for rendering, generated by itself.”
UE-A may generate UE-A.ePK and UE-A.eSK which are a public key pair of a public cryptosystem (key pair of public cryptosystem).
UE-A may transmit at least one of an attestation or certificate of UE-A to the network (e.g., XR AS). The attestation of UE-A may include one or more of the following pieces of information:
   Avatar ID indicating an avatar object of UE-A.
   Information indicating an XR AS, such as an identifier or address of the XR AS, or the like.

Rendering option information indicating that transmission UE centric rendering is to be performed.
The generated UE-A.ePK.
Information associated with a time during which an attestation is valid. For example, expiration. As another example, a generation time and duration time of the attestation.

### IMPU

Electronic signature information generated for a portion and/or all of the information. The electronic signature may be an electronic signature generated with UE-A.SK.

Before transmitting the attestation or certificate of UE-A to the XR AS, an IMS network (e.g., DCSF, MF, or the like) may determine whether an IMPU available for UE-A is included in the information or an avatar ID available for UE-A is included, and may transmit the attestation or certificate of UE-A to the XR-AS.

In step 304, UE-A and/or network and/or UE-B may establish a data channel for data transmission, and may perform renegotiation about media to be transmitted.

At least one of the attestation or certificate of UE-A may be transmitted in step 303 or 304. Alternatively, at least one of the attestation or certificate of UE-A may be transmitted in steps 303 and 304.

The attestation of UE-A may include one or more of the following information.
Avatar ID indicating an avatar object of UE-A.
Information indicating an XR AS, such as an identifier or address of the XR AS, or the like.
Rendering option information indicating that transmission UE centric rendering is to be performed.
   The generated UE-A.ePK.
   Information associated with a time during which an attestation is valid, such as expiration or a generation time and duration time of the attestation.
ID of UE-A (e.g., IMPU, mobile station international subscriber directory number (MSISDN), int'l mobile subscriber identity (IMSI), or the like).
   Electronic signature information generated for a portion and/or all of the information. The electronic signature may be an electronic signature generated with UE-A.SK.

Whether to transmit at least one of the attestation or certificate of UE-A in at least one of steps 303 and 304 may be determined according to implementation. For example, it may be determined based on determination or negotiation by at least one of communication entities such as a UE, a network operator, or the like.

When transmitting the attestation or certificate of UE-A, before transmitting the attestation or certificate of UE-A to the XR AS, the IMS network (e.g., DCSF, MF, or the like) may determine whether the IMPU available for UE-A is included in the information or the avatar ID available for UE-A is included, and may transmit the same to the XR-AS.

In step 305, the XR AS may request an avatar object of UE-A from a BAR. In step 305, the attestation of UE-A may be used.

In step 306, the BAR may perform one or more of the following processes:
Verify the attestation of UE-A. The verification may include one or more of the following processes.
Verify validity of an electronic signature included in the certificate, using a public key of the BAR or a public key of the IMS network (e.g., DSCF, MF, or the like).
   Verify validity of an electronic signature included in the attestation of UE-A. The verification may be performed using UE-A.PK.
Identify content included in the attestation of UE-A. The verification may include one or more of the following processes.
Determine whether UE-A having the IMPU included in the certificate is allowed to use the avatar ID included in the attestation.
Identify the avatar ID included in the attestation of UE-A, and may select and/or prepare for transmission of an avatar object of the corresponding UE-A.
Identify information of the XR AS included in the attestation of UE-A, may check whether the information is identical to information of the XR AS that requests the avatar object of UE-A, and may perform identification.
Identify and recognize that transmission UE centric rendering is to be performed via rendering option information included in the attestation of UE-A.
   Obtain UE-A.ePK included in the attestation of UE-A.
Identify time information included in the attestation of UE-A, may check whether the attestation of UE-A is still valid, and may perform identification.

When the verification succeeds, the BAR may perform one or more of the following processes.
Generate BAR.ePK and BAR.eSK which are a public key pair of a public cryptosystem (key pair of public cryptosystem).
Generate an encryption key(s) to be used for protecting the avatar object of UE-A by using the BAR.eSK and UE-A.ePK.
Protect the avatar object of UE-A by using the generated encryption key(s). For example, the BAR may encrypt the avatar object of UE-A by using the generated encryption key, generate information for verifying integrity of the avatar object of UE-A by using the generated encryption key, or generate a protected avatar object by using the avatar object of UE-A, and/or the encrypted avatar object of UE-A, and/or the generated integrity verification information.

When the process is completed, the BAR transmits one or more from among the following information to the XR AS.
Transmit the protected avatar object of UE-A to the XR AS
Transmit the BAR.ePK to the XR AS.

In step 307, the XR AS may transmit the protected avatar object of UE-A to UE-A, or may transmit the BAR.ePK to UE-A.

In step 308, UE-A may perform one or more of the following processes.
UE-A may generate an encryption key(s) used for protecting the avatar object of UE-A by using the BAR.ePK and UE-A.eSK.
UE-A may extract valid information from the received protected avatar object and/or may perform validity verification by using the generated encryption key(s). For example, UE-A may decrypt the encrypted avatar object of UE-A by using the generated encryption key. For example, UE-A may verify the integrity of the protected avatar object of UE-A by using the generated encryption key. Via the process, UE-A may obtain and/or verify an avatar object to be used for rendering.
UE-A may perform rendering by using the “obtained its own avatar object” and the “data needed for rendering, generated by itself.” As a result of rendering, avatar animation may be generated.

In step 309, UE-A may perform one or more of the following processes.
UE-A may transmit the generated rendering result (e.g., avatar animation) to UE-B.

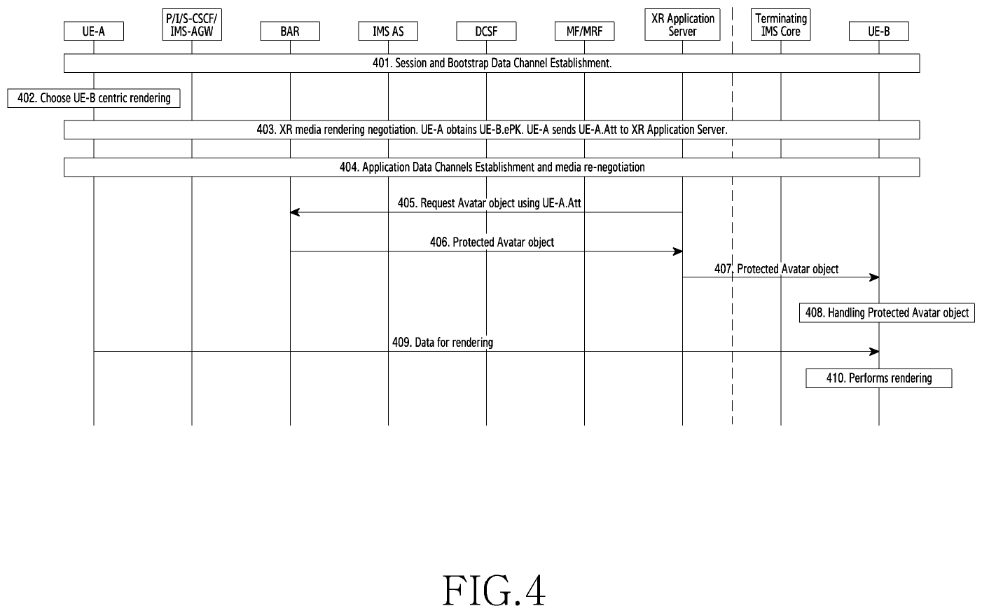

FIG. 4 illustrates a process of transmitting an avatar object for reception UE centric (UE-B centric) avatar communication according to an embodiment.

Referring to FIG. 4, in step 401, UE-A and/or a network and/or UE-B may set up a session for avatar communication, and may establish a data channel for bootstrap data transmission.

In step 402, UE-A may select reception UE centric (UE-B centric)-based avatar communication.

In step 403, one or more of the following processes may be performed.

UE-A and/or network and/or UE-B may perform negotiation about a rendering scheme, which is a process of agreeing that the following process is to be performed for avatar communication.
UE-B may perform rendering by using an “avatar object of UE-A received from an XR AS” and “data needed for rendering, received from UE-A.”
UE-B may generate UE-B.ePK and UE-B.eSK which are a public key pair of a public cryptosystem (key pair of public cryptosystem).
UE-A may obtain UE-B.ePK.
UE-A may transmit at least one of the attestation or certificate of UE-A to the network (e.g., XR AS). The attestation of UE-A may include one or more of the following pieces of information:
   Avatar ID indicating an avatar object of UE-A.
   Information indicating an XR AS, such as an identifier or address of the XR AS, or the like.
Rendering option information indicating that reception UE centric rendering is to be performed.
   The obtained UE-B.ePK.
   Information associated with a time during which an attestation is valid, such as expiration or a generation time and duration time of the attestation.
   ID of UE-A (e.g., IMPU, MSISDN, IMSI, or the like).
   Electronic signature information generated for a portion and/or all of the information. The electronic signature may be an electronic signature generated with UE-A.SK.

Before transmitting the attestation or certificate of UE-A to the XR AS, an IMS network (e.g., DCSF, MF, or the like) may determine whether an IMPU available for UE-A is included in the information or an avatar ID available for UE-A is included, and may transmit the same to the XR-AS.

In step 404, UE-A and/or network and/or UE-B may establish a data channel for data transmission, and may perform renegotiation about media to be transmitted.

At least one of the attestation or certificate of UE-A may be transmitted in step 403 or 404. Alternatively, at least one of the attestation or certificate of UE-A may be transmitted in steps 403 and 404.

The attestation of UE-A may include one or more of the following pieces of information:
Avatar ID indicating an avatar object of UE-A.
Information indicating an XR AS, such as an identifier or address of the XR AS, or the like.
Rendering option information indicating that transmission UE centric rendering is to be performed.
   The generated UE-A.ePK.
   Information associated with a time during which an attestation is valid, such as expiration or a generation time and duration time of the attestation.

### IMPU

Electronic signature information generated for a portion and/or all of the information. The electronic signature may be an electronic signature generated with UE-A.SK.

Whether to transmit at least one of the attestation or certificate of UE-A in at least one of steps 403 and 404 may be determined according to implementation. For example, it may be determined based on determination or negotiation by at least one of communication entities such as a UE, a network operator, or the like.

When transmitting the attestation or certificate of UE-A, before transmitting the attestation or certificate of UE-A to the XR AS, an IMS network (e.g., DCSF, MF, etc.) may determine whether an IMPU available for UE-A is included in the information or an avatar ID available for UE-A is included, and may transmit the same to the XR-AS.

In step 405, the XR AS may request an avatar object of UE-A from a BAR. In step 405, the attestation of UE-A may be used.

In step 406, the BAR may perform one or more of the following processes.
Verify the attestation of UE-A. The verification may include one or more of the following processes.
Verify validity of an electronic signature included in the certificate, using a public key of the BAR or a public key of the IMS network (e.g., DSCF, MF, etc.).
Verify validity of an electronic signature included in the attestation of UE-A, using UE-A.PK.
Identify content included in the attestation of UE-A. The verification may include one or more of the following processes.
Determine whether UE-A having the IMPU included in the certificate is allowed to use the avatar ID included in the attestation.
Identify the avatar ID included in the attestation of UE-A, and may select and/or prepare for transmission of an avatar object of the corresponding UE-A.
Identify information of the XR AS included in the attestation of UE-A, may check whether the information is identical to information of the XR AS that requests the avatar object of UE-A, and may perform identification.
Identify and recognize that reception UE centric rendering is to be performed via rendering option information included in the attestation of UE-A.
Obtain UE-B.ePK included in the attestation of UE-A.
Identify time information included in the attestation of UE-A, check whether the attestation of UE-A is still valid, and perform identification.

When the verification succeeds, the BAR may perform one or more of the following processes.
Generate BAR.ePK and BAR.eSK which are a public key pair of a public cryptosystem (key pair of public cryptosystem).
Generate an encryption key(s) to be used for protecting the avatar object of UE-A by using the BAR.eSK and UE-B.ePK.
   Protect the avatar object of UE-A by using the generated encryption key(s). For example, the BAR may encrypt the avatar object of UE-A by using the generated encryption key, generate information for verifying integrity of the avatar object of UE-A by using the generated encryption key, and generate a protected avatar object by using the avatar object of UE-A, and/or the encrypted avatar object of UE-A, and/or the generated integrity verification information.

When the process is completed, the BAR may transmit the protected avatar object of UE-A to the XR AS or may transmit the BAR.ePK to the XR AS.

In step 407, the XR AS may transmit the protected avatar object of UE-A to UE-B, or may transmit the BAR.ePK to UE-B.

In step 408, UE-B may perform one or more of the following processes.
Generate an encryption key(s) used for protecting the avatar object of UE-A by using the BAR.ePK and UE-B.eSK.
Extract valid information from the received protected avatar object and/or may perform validity verification by using the generated encryption key(s), such as decrypt the encrypted avatar object of UE-A by using the generated encryption key, and verify the integrity of the protected avatar object of UE-A by using the generated encryption key. Via the process, UE-B may obtain and/or verify an avatar object to be used for rendering.

In step 409, UE-A may transmit data needed for rendering to UE-B.

In step 410, UE-B may perform avatar rendering by using the “obtained avatar object of UE-A” and the “data needed for rendering, received from UE-A.” As a result of avatar rendering, avatar animation may be generated.

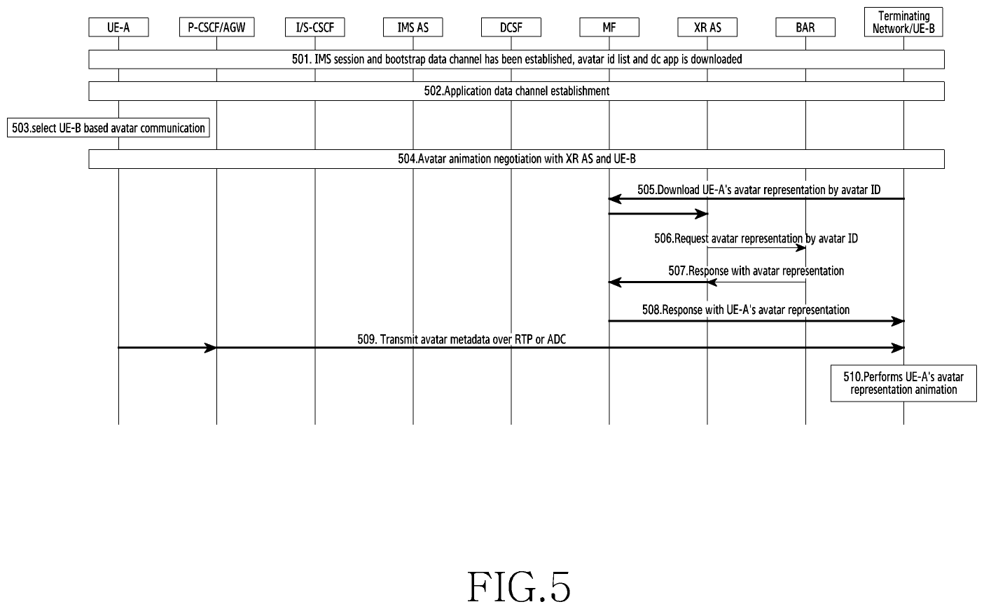

FIG. 5 illustrates a process of transmitting an avatar object for UE-B centric avatar communication according to an embodiment.

Referring to FIG. 5, in step 501, UE-A and/or a network and/or UE-B may set up a session for avatar communication, and may establish a data channel for bootstrap data transmission.

In step 502, a peer to application to peer (P2A2P) application data channel may be generated between UE-A/UE-B and an XR AS.

In step 503, UE-A may select UE-B centric-based avatar communication.

In step 504, one or more of the following processes may be performed.
UE-A and/or network and/or UE-B may perform negotiation about a rendering scheme by agreeing that the following process is to be performed for avatar communication.
UE-B may perform rendering by using an “avatar object of UE-A received from an XR AS” and “data needed for rendering, received from UE-A.”
UE-B may generate UE-B.ePK and UE-B.eSK which are a public key pair of a public cryptosystem (key pair of public cryptosystem).
UE-A may obtain UE-B.ePK.
UE-A may transmit at least one of an attestation or certificate of UE-A to the network (e.g., XR AS, BAR, or the like) or UE-B. The attestation of UE-A may include one or more of the following pieces of information:
   Avatar ID indicating an avatar object of UE-A.
   Information indicating an XR AS, such as an identifier or address of the XR AS, or the like.

Rendering option information indicating that reception UE centric rendering is to be performed.
The obtained UE-B.ePK.
Information associated with a time during which an attestation is valid, such as expiration or a generation time and duration time of the attestation.
ID of UE-A (e.g., IMPU, MSISDN, IMSI, or the like).
ID of UE-B (e.g., IMPU, MSISDN, IMSI, or the like).
Electronic signature information generated for a portion and/or all of the information. The electronic signature may be an electronic signature generated with UE-A.SK.
UE-A may transmit an avatar ID to UE-B.

Before transmitting the attestation or certificate of UE-A to the XR AS, an IMS network (e.g., DCSF, MF, or the like) may determine whether an IMPU available for UE-A is included in the information or an avatar ID available for UE-A is included, and may transmit the attestation or certificate of UE-A to the XR-AS.

The attestation of UE-A may include one or more of the following pieces of information:
Avatar ID indicating an avatar object of UE-A.
Information indicating an XR AS, such as an identifier or address of the XR AS, or the like.
Rendering option information indicating that transmission UE centric rendering is to be performed.
   The generated UE-A.ePK.
   Information associated with a time during which an attestation is valid, such as expiration or a generation time and duration time of the attestation.
   ID of UE-A (e.g., IMPU, MSISDN, IMSI, etc.).
   ID of UE-B (e.g., IMPU, MSISDN, IMSI, etc.).
   Electronic signature information generated for a portion and/or all of the information. The electronic signature may be an electronic signature generated with UE-A.SK.

Whether to transmit at least one of the attestation or certificate of UE-A may be determined according to implementation. For example, it may be determined based on determination or negotiation by at least one of communication entities such as a UE, a network operator, or the like.

When transmitting the attestation or certificate of UE-A, before transmitting the attestation or certificate of UE-A to the XR AS, the IMS network (e.g., DCSF, MF, or the like) may determine whether the IMPU available for UE-A is included in the information or the avatar ID available for UE-A is included, and may transmit the same to the XR-AS.

In step 505, UE-B may request an avatar object of UE-A from an MF. In step 505, at least one of the attestation, the certificate of UE-A, the avatar ID of UE-A, and the ID (e.g., IMPU, MSISDN, IMSI, etc.) of UE-B may be used.

In step 506, the MF may request the avatar ID of UE-A from a BAR via the XR AS by using the information received in step 505.

In step 507, the BAR may verify the attestation of UE-A received in step 504 or 506. The verification may include one or more of the following processes performed by the BAR.
Verify validity of an electronic signature included in the certificate using a public key of the BAR or a public key of the IMS network (e.g., DSCF, MF, etc.).
Verify validity of an electronic signature included in the attestation of UE-A using UE-A.PK.
   Identify content included in the attestation of UE-A. The verification may include one or more of the following processes.
Determine whether UE-A having the ID of UE-A included in the certificate is allowed to use the avatar ID included in the attestation.
   Identify the avatar ID included in the attestation of UE-A, and select and/or prepare for transmission of an avatar object of the corresponding UE-A.
Identify information of the XR AS included in the attestation of UE-A, check whether the information is identical to information of the XR AS that requests the avatar object of UE-A, and perform identification.
   Identify and recognize that reception UE centric rendering is to be performed via rendering option information included in the attestation of UE-A.
Determine whether the ID of UE-B included in the attestation of UE-A is identical to an ID of UE-B received in step 506.
Obtain UE-B.ePK included in the attestation of UE-A.
Identify time information included in the attestation of UE-A, check whether the attestation of UE-A is still valid, and perform identification.

When the verification succeeds, the BAR may perform one or more of the following processes.
Generate BAR.ePK and BAR.eSK which are a public key pair of a public cryptosystem (key pair of public cryptosystem). Generate an encryption key(s) to be used for protecting the avatar object of UE-A by using the BAR.eSK and UE-B.ePK. Protect the avatar object of UE-A by using the generated encryption key(s). For example, the BAR may encrypt the avatar object of UE-A by using the generated encryption key, generate information for verifying integrity of the avatar object of UE-A by using the generated encryption key, and generate a protected avatar object by using the avatar object of UE-A, and/or the encrypted avatar object of UE-A, and/or the generated integrity verification information.

When the process is completed, the BAR may transmit the protected avatar object of UE-A or may transmit the BAR.ePK.

In step 508, the MF may transmit the protected avatar object of UE-A to UE-B or may transmit the BAR.ePK to UE-B.

In step 509, UE-A may transmit data needed for rendering to UE-B.

In step 510, UE-B may perform one or more of the following processes.
Generate an encryption key(s) used for protecting the avatar object of UE-A by using the BAR.ePK and UE-B.eSK.
Extract valid information from the received protected avatar object and/or may perform validity verification by using the generated encryption key(s). For example, UE-B may decrypt the encrypted avatar object of UE-A by using the generated encryption key, and verify the integrity of the protected avatar object of UE-A by using the generated encryption key. Via the process, UE-B may obtain and/or verify an avatar object of UE-A to be used for rendering.
UE-B may perform avatar rendering by using the “obtained avatar object of UE-A” and the “data needed for rendering, received from UE-A.” As a result of avatar rendering, avatar animation may be generated.

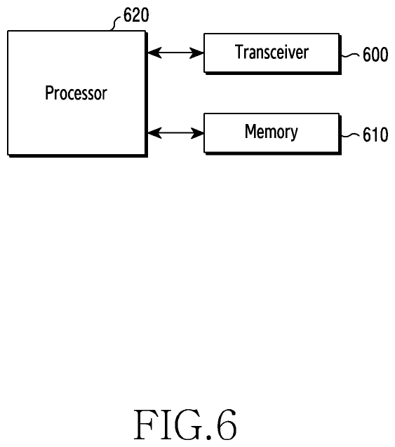

FIG. 6 illustrates a structure of a UE according to an embodiment.

Referring to FIG. 6, a UE may include a processor 620, a transceiver 600, and a memory 610. However, components of the UE are not limited to the above-described example. For example, the UE may include more or fewer components than the above-described components. In addition, the processor 620, the transceiver 600, and the memory 610 may be implemented in the form of a single chip.

The processor 620 may control a series of processes so that the UE can operate according to the above-described embodiments of the disclosure. For example, the processor 620 may control the components of the UE to perform the above method for avatar object security according to the above-described embodiments. The processor 620 may control the components of the UE to perform the embodiments of the disclosure by executing the programs stored in the memory 610. In addition, the processor 620 may be an application processor (AP), a communication processor (CP), a circuit, an application-specific circuit, or at least one processor.

The transceiver 600 may transmit/receive signals with network entities, other UEs, or base stations. The signals transmitted/received with network entities, other UEs, or base stations may include control information and data. The transceiver 600 may include an RF transmitter configured to up-convert and amplify the frequency of transmitted signals, an RF receiver configured to low-noise-amplify received signals and down-convert the frequency thereof, and the like. However, this is only an embodiment of the transceiver 600, and the components of the transceiver 600 are not limited to the RF transmitter and the RF receiver. In addition, the transceiver 600 may receive signals through a radio channel, output the same to the processor 620, and transmit signals output from the processor 620 through the radio channel.

The memory 610 may store programs and data necessary for operations of the UE. In addition, the memory 610 may store control information or data included in signals transmitted/received by the UE. The memory 610 may include storage media such as a read only memory (ROM), a random access memory (RAM), a hard disk, a compact disc (CD)-ROM, and a digital versatile disc (DVD), or a combination of storage media. In addition, the memory 610 may include multiple memories. The memory 610 may store programs for executing the above method for avatar object security.

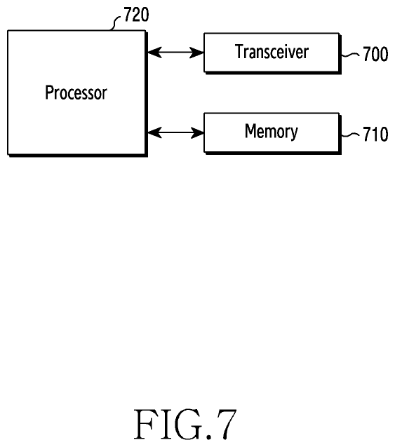

FIG. 7 illustrates a structure of a base station according to an embodiment.

Referring to FIG. 7, a base station may include a processor 720, a transceiver 700, and a memory 710. However, components of the base station are not limited to the above-described example. For example, the base station may include more or fewer components than the above-described components. In addition, the processor 720, the transceiver 700, and the memory 710 may be implemented in the form of a single chip.

The processor 720 may control a series of processes in which the base station can operate according to the above-described embodiments of the disclosure. For example, the processor 720 may control the components of the base station to perform the above method for avatar object security according to the above-described embodiments. The processor 720 may control the components of the base station to perform the embodiments of the disclosure by executing programs stored in the memory 710. In addition, the processor 720 may be an AP, a CP, a circuit, an application-specific circuit, or at least one processor.

The transceiver 700 may transmit/receive signals with network entities, other base stations, or UEs. The signals transmitted/received with network entities, other base stations, or UEs may include control information and data. The transceiver 700 may include an RF transmitter configured to up-convert and amplify the frequency of transmitted signals, an RF receiver configured to low-noise-amplify received signals and down-convert the frequency thereof, and the like. However, this is only an embodiment of the transceiver 700, and the components of the transceiver 700 are not limited to the RF transmitter and the RF receiver. In addition, the transceiver 700 may receive signals through a radio channel, output the same to the processor 720, and transmit signals output from the processor 720 through the radio channel.

The memory 710 may store programs and data necessary for operations of the base station. In addition, the memory 710 may store control information or data included in signals transmitted/received by the base station. The memory 710 may include storage media such as a ROM, a RAM, a hard disk, a CD-ROM, and a DVD, or a combination of storage media. In addition, the memory 710 may include multiple memories. The memory 710 may store programs for executing the above method for avatar object security.

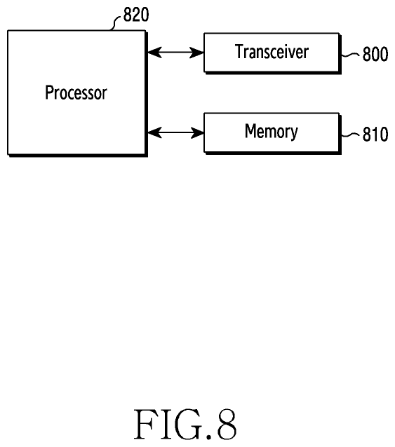

FIG. 8 illustrates a structure of a network entity according to an embodiment. Referring to FIG. 8, a network entity may include a processor 820, a transceiver 800, and a memory 810. However, components of the network entity are not limited to the above-described example. For example, the network entity may include more or fewer components than the above-described components. In addition, the processor 820, the transceiver 800, and the memory 810 may be implemented in the form of a single chip. The network entity may refer to a network function (NF), and the NF may include all of the above-described entities.

The processor 820 may control a series of processes so that the NF can operate according to the above-described embodiments of the disclosure. For example, the processor 820 may control the components of the network entity to perform the above method for avatar object security according to the above-described embodiments. The processor 820 may control the components of the network entity to perform the embodiments of the disclosure by executing the programs stored in the memory 810. In addition, the processor 820 may be an AP, a CP, a circuit, an application-specific circuit, or at least one processor.

The transceiver 800 may transmit/receive signals with other network entities, base stations, or UEs. The signals transmitted/received with other network entities or UEs may include control information and data. The transceiver 800 may include an RF transmitter configured to up-convert and amplify the frequency of transmitted signals, an RF receiver configured to low-noise-amplify received signals and down-convert the frequency thereof, and the like. However, this is only an embodiment of the transceiver 800, and the components of the transceiver 800 are not limited to the RF transmitter and the RF receiver. In addition, the transceiver 800 may receive signals through a radio channel, output the same to the processor 820, and transmit signals output from the processor 820 through the radio channel.

The memory 810 may store programs and data necessary for operations of the network entity. In addition, the memory 810 may store control information or data included in signals transmitted/received by the network entity. The memory 810 may include storage media such as a ROM, a RAM, a hard disk, a CD-ROM, and a DVD, or a combination of storage media. In addition, the memory 810 may include multiple memories. The memory 810 may store programs for executing the above method for avatar object security.

It should be noted that the configuration diagrams, illustrative diagrams of control/data signal transmission methods, and illustrative diagrams of operation procedures as illustrated in FIG. 1 to FIG. 8 are not intended to limit the scope of protection of the disclosure. That is, all the constituent elements, entities, or operation steps shown and described in FIG. 1 to FIG. 8 should not be construed as being essential elements for the implementation of the disclosure, and even when including only some of the elements, the disclosure may be implemented without impairing the true of the disclosure.

The above-described operations of the embodiments may be implemented by providing any unit of a device with a memory device storing corresponding program codes. That is, a controller in the device may perform the above-described operations by reading and executing the program codes stored in the memory device by means of a processor or central processing unit (CPU).

Various units or modules of an entity or terminal device set forth herein may be operated using hardware circuits such as complementary metal oxide semiconductor-based logic circuits, firmware, or hardware circuits such as combinations of software and/or hardware and firmware and/or software embedded in a machine-readable medium. For example, various electrical structures and methods may be implemented using transistors, logic gates, and electrical circuits such as application-specific integrated circuits.

Herein, each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in various embodiments of the disclosure, a “unit” refers to a software element or a hardware element, such as a field programmable gate array (FPGA) or an application specific integrated circuit (ASIC), which performs a predetermined function. However, the unit does not always have a meaning limited to software or hardware. The unit may be constructed either to be stored in an addressable storage medium or to execute one or more processors. Therefore, the unit includes software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the unit may be either combined into fewer elements, or a unit, or divided into more elements, or a unit. Moreover, the elements and units may be implemented to reproduce one or more CPUs within a device or a security multimedia card.

These programs (software modules or software) may be stored in non-volatile memories including a random access memory and a flash memory, a read only memory (ROM), an electrically erasable programmable read only memory (EEPROM), a magnetic disc storage device, a CD-ROM, DVDs, or other type optical storage devices, or a magnetic cassette. Alternatively, any combination of some or all of them may form a memory in which the program is stored. In addition, a plurality of such memories may be included in the electronic device.

The programs may be stored in an attachable storage device which can access the electronic device through communication networks such as the Internet, Intranet, local area network (LAN), wide LAN (WLAN), and storage area network (SAN) or a combination thereof. Such a storage device may access the electronic device via an external port. A separate storage device on the communication network may access a portable electronic device.

While the disclosure has been described with reference to various embodiments, various changes may be made without departing from the spirit and the scope of the present disclosure, which is defined, not by the detailed description and embodiments, but by the appended claims and their equivalents.

What is claimed is:

1. A method performed by a transmitting user equipment (UE) for providing an avatar service through avatar communication, the method comprising:
establishing a channel for the avatar communication with a network entity and a UE receiving the avatar service;
transmitting, to the network entity, attestation information including identification information of an avatar object to be used for the avatar communication by the transmitting UE, and an encryption information of a rendering entity generated by the rendering entity; and
acquiring data required for rendering corresponding to the encrypted avatar object based on the encryption information of the rendering entity,
wherein the encrypted avatar object is encrypted based on verification of the attestation information and the identification information, and
wherein the encrypted avatar object is provided to the rendering entity.

2. The method of claim 1,
wherein the attestation information comprises at least one of rendering option information comprising information regarding a rendering scheme, or electronic signature information generated based on encryption information of the transmitting UE generated by the transmitting UE,
wherein the rendering scheme is distinguished according to whether the transmitting UE selects one of the transmitting UE or the receiving UE as the rendering entity, and
wherein the electronic signature information is used to verify that the attestation information is generated by the transmitting UE.

3. The method of claim 2,
wherein the encryption information of the rendering entity comprises a public key and a secret key of the rendering entity,
wherein the encryption information of the transmitting UE comprises a public key and a secret key of the transmitting UE,
wherein the electronic signature information is generated based on the secret key of the transmitting UE, and
wherein the attestation information comprises the public key of the rendering entity.

4. The method of claim 1,
wherein when the rendering entity is the receiving UE,
the encryption information of the rendering entity comprises encryption information of the receiving UE generated by the receiving UE,
the encryption information of the receiving UE is received from the receiving UE, and
the method further comprises transmitting the data required for the rendering to the receiving UE.

5. The method of claim 1,
wherein when the rendering entity is the transmitting UE,
the encryption information of the rendering entity comprises encryption information of the transmitting UE generated by the transmitting UE, and
the method further comprises:
receiving, from the network entity, the encrypted avatar object and encryption information of the network entity generated by the network entity;
decoding the encrypted avatar object using the encryption information of the network entity and the encryption information of the transmitting UE;
acquiring a decoded avatar object;
generating avatar animation using the decoded avatar object and the data required for the rendering; and
transmitting the generated avatar animation to the receiving UE.

6. A method performed by a network entity for avatar communication, the method comprising:
establishing a channel for the avatar communication with a transmitting UE providing an avatar service and a UE receiving the avatar service;
receiving, from the transmitting UE, attestation information comprising identification information of an avatar object to be used for the avatar communication by the transmitting UE and encryption information of a rendering entity generated by the rendering entity;
verifying the attestation information;
acquiring an encrypted avatar object based on a result of verification of the attestation information by using the identification information, the encryption information of the rendering entity, and encryption information of the network entity generated by the network entity; and
transmitting the encrypted avatar object and the encryption information of the network entity to the rendering entity.

7. The method of claim 6,
wherein the attestation information comprises at least one of rendering option information comprising information regarding a rendering scheme, or electronic signature information generated based on encryption information of the transmitting UE generated by the transmitting UE,
wherein the rendering scheme is distinguished according to the rendering entity determined by the transmitting UE, and
wherein the electronic signature information is used to verify that the attestation information is generated by the transmitting UE.

8. The method of claim 7,
wherein the encryption information of the transmitting UE comprises a public key and a secret key of the transmitting UE,
wherein the electronic signature information is generated based on the secret key of the transmitting UE, and
wherein verifying the attestation information comprises verifying validity of the electronic signature information using the public key of the transmitting UE.

9. The method of claim 8,
wherein the encryption information of the rendering entity comprises a public key and a secret key of the rendering entity,
wherein acquiring the encrypted avatar object comprises:
generating encryption information of the network entity comprising a public key and a secret key of the network entity; and
acquiring the encrypted avatar object using the secret key of the network entity and the public key of the rendering entity, and
wherein the public key of the network entity is provided to the rendering entity.

10. The method of claim 6,
wherein the rendering entity comprises at least one of the transmitting UE or the receiving UE.

11. A transmitting user equipment (UE) that provides an avatar service for avatar communication, the transmitting UE comprising:
at least one processor;
a transceiver; and
a memory,
wherein the at least one processor is configured to:
establish a channel for the avatar communication with a network entity and a UE receiving the avatar service;
transmit, to the network entity, attestation information comprising identification information of an avatar object to be used for the avatar communication by the transmitting UE and encryption information of a rendering entity generated by the rendering entity; and
acquire data required for rendering based on the encryption information of the rendering entity,
wherein the encrypted avatar object is determined by encrypting the avatar object based on the verification of the attestation information and the identification information, and
wherein the encrypted avatar object is provided to the rendering entity.

12. The transmitting UE of claim 11,
wherein the attestation information comprises at least one of rendering option information comprising information regarding a rendering scheme, or electronic signature information generated based on encryption information of the transmitting UE generated by the transmitting UE,
wherein the rendering scheme is distinguished according to whether the transmitting UE selects one of the transmitting UE or the receiving UE as the rendering entity, and
wherein the electronic signature information is used to verify that the attestation information is generated by the transmitting UE.

13. The transmitting UE of claim 12,
wherein the encryption information of the rendering entity comprises a public key and a secret key of the rendering entity,
wherein the encryption information of the transmitting UE comprises a public key and a secret key of the transmitting UE,
wherein the electronic signature information is generated based on the secret key of the transmitting UE, and
wherein the attestation information comprises the public key of the rendering entity.

14. The transmitting UE of claim 11,
wherein when the rendering entity is the receiving UE,
the encryption information of the rendering entity comprises encryption information of the receiving UE generated by the receiving UE,
the encryption information of the receiving UE is received from the receiving UE, and
the at least one processor is further configured to transmit the data required for the rendering to the receiving UE.

15. The transmitting UE of claim 11,
wherein when the rendering entity is the transmitting UE,
the encryption information of the rendering entity comprises encryption information of the transmitting UE generated by the transmitting UE, and
the at least one processor is further configured to:
receive, from the network entity, the encrypted avatar object and encryption information of the network entity generated by the network entity;
decode the encrypted avatar object using the encryption information of the network entity and the encryption information of the transmitting UE;
acquire a decoded avatar object;
generate an avatar animation using the decoded avatar object and the data required for the rendering; and
transmit the generated avatar animation to the receiving UE.

16. A network entity for avatar communication, comprising:
at least one processor;
a transceiver; and
a memory,
wherein the at least one processor is configured to:
establish a channel for the avatar communication with a transmitting UE providing an avatar service and a UE receiving the avatar service;
receive, from the transmitting UE, attestation information comprising identification information of an avatar object to be used for the avatar communication by the transmitting UE and encryption information of a rendering entity generated by the rendering entity;
verify the attestation information;
acquire an encrypted avatar object based on a result of verification of the attestation information by using the identification information, the encryption information of the rendering entity, and encryption information of the network entity generated by the network entity; and
transmit the encrypted avatar object and the encryption information of the network entity to the rendering entity.

17. The transmitting UE of claim 16,
wherein the attestation information comprises at least one of rendering option information comprising information regarding a rendering scheme, or electronic signature information generated based on encryption information of the transmitting UE generated by the transmitting UE,
wherein the rendering scheme is distinguished according to the rendering entity determined by the transmitting UE, and
wherein the electronic signature information is used to verify that the attestation information is generated by the transmitting UE.

18. The transmitting UE of claim 17,
wherein the encryption information of the transmitting UE comprises a public key and a secret key of the transmitting UE,
wherein the electronic signature information is generated based on the secret key of the transmitting UE, and
wherein verifying the attestation information comprises verifying validity of the electronic signature information using the public key of the transmitting UE.

19. The transmitting UE of claim 18,
wherein the encryption information of the rendering entity comprises a public key and a secret key of the rendering entity,
wherein acquiring the encrypted avatar object comprises:
generating encryption information of the network entity comprising a public key and a secret key of the network entity, and
acquiring the encrypted avatar object using the secret key of the network entity and the public key of the rendering entity, and
wherein the public key of the network entity is provided to the rendering entity.

20. The transmitting UE of claim 16,
wherein the rendering entity comprises at least one of the transmitting UE or the receiving UE.
